(19) United States
(12) Patent Application Publication
(10) Pub. No.: US 2009/0049133 A1
(43) Pub. Date: Feb. 19, 2009

(54) METHOD AND APPARATUS FOR ASSIGNING AN INSTANT MESSAGE PERSONA TO MANAGE A SERVICE DESK ENVIRONMENT

(76) Inventors: Michael L. Odom, Austin, TX (US); Sriraman Padmanabhan, Austin, TX (US); Jesus Alberto Saenz, Austin, TX (US)

Correspondence Address: IBM CORP (YA);C/O YEE & ASSOCIATES PC, P.O. BOX 802333, DALLAS, TX, 75380, US

(21) Appl. No.: 11/839,370

(22) Filed: Aug. 15, 2007

(51) Int. Cl. G06F 15/16; G06F 17/30

(52) U.S. Cl. 709/206; 707/3

(57) ABSTRACT

A computer implemented method, apparatus, and computer usable program product for managing a service desk environment. The process receives a request from the user. The request is received via instant messenger and includes at least one of a set of predefined messages. The process then identifies a source of information for generating a response to the request from the user. Thereafter, the process queries the source of information using the set of predefined messages to form a response to the request from the user. The process then presents the response to the user via instant messenger.

### BACKGROUND OF THE INVENTION

1. Field of the Invention

The present invention relates generally to an improved data processing system, and in particular to a computer implemented method and apparatus for utilizing instant messaging for managing a service desk environment. Still more particularly, the present invention relates to a computer implemented method, apparatus, and computer usable program product for assigning an automated administrator persona to a service desk deployment for enabling intelligent communication between service desk users and the automated administrator persona via instant messaging technology.

2. Description of the Related Art

A service desk is an application for providing a single point of contact for users to facilitate incident and problem management. Users may include, for example, end-users, service desk operators, technical support staff, or administrators. Typically, first level service desk operators at a call center utilize the service desk application to document the incidents and problems reported by end-users. The first level operator may provide the end-user with requested information or offer solutions to simple, frequently encountered problems. First level service operators may also connect end-users with other, more experienced service desk operators, technical support staff, and service technicians. These more experienced operators, support staff, and technicians, also known as subject matter experts (SMEs), may provide more advanced troubleshooting solutions or may make service calls to assist an end-user.

Incidents and problems are documented by the creation of a ticket. An incident is an occurrence or event that disrupts or affects service quality. A problem is an incident whose root cause is unknown and may potentially require corrective action by an operator of a service desk environment. A ticket is a file that contains information about support interventions made by technical support staff or third parties on behalf of a client who has reported an incident or problem. Periodically, the ticket is updated with the current status of the client's problem. Tickets are closed when the problem is resolved.

Subject matter experts may also utilize the service desk environment to assist end-users, retrieve additional information that may assist the resolution of an end-user's problem, and provide updates on the status of open tickets. To access this information, however, subject matter experts must either have access to a console to utilize the service desk or contact a service desk operator to retrieve the necessary information.

This currently used method for implementing a service desk environment is time consuming because it requires communication to pass through multiple levels of operators for resolving incidents and problems. Furthermore, a service operator in the field may lack the ability to easily access necessary information to remedy identified problems. Moreover, the employment of numerous operators is costly, and increases the chance for human error.

### SUMMARY OF THE INVENTION

The illustrative embodiments described herein provide a computer implemented method, apparatus, and computer program product for managing a service desk environment. The process receives a request from the user. The request is received via instant messenger and includes at least one of a set of predefined messages. The process then identifies a source of information for generating a response to the request from the user. Thereafter, the process queries the source of information using the set of predefined messages to form a response to the request from the user. The process then presents the response to the user via instant messenger

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a data processing system in which the illustrative embodiments may be implemented;

FIG. 3 is a diagram of components usable for managing a service desk environment in accordance with an illustrative embodiment;

FIG. 4 is a screenshot of an instant messenger application window in accordance with an illustrative embodiment;

FIG. 5 is a flowchart of a process for assigning a request from a client to a service operator in accordance with an illustrative embodiment; and

FIG. 6 is a flowchart of a process for generating a response by a service desk persona in accordance with an illustrative embodiment.

### DETAILED DESCRIPTION OF THE PREFERRED EMBODIMENT

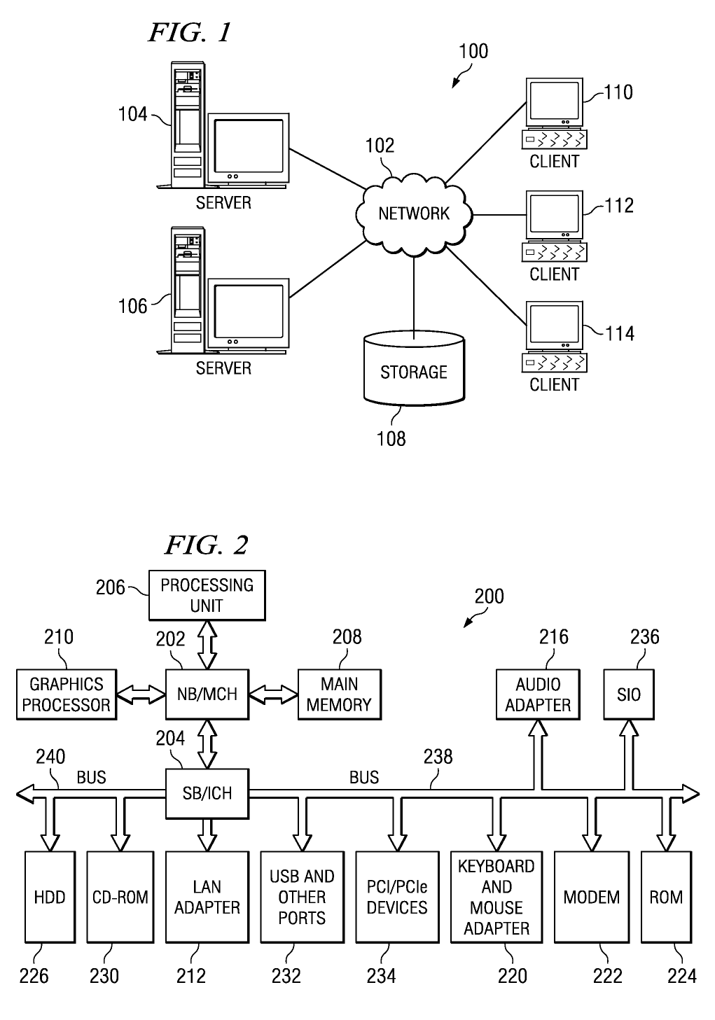

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft Windows® XP (Microsoft and Windows are trademarks of Microsoft Corporation in the United States, other countries, or both). An object oriented programming system, such as the Java programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer implemented method, apparatus, and computer program product for managing a service desk environment. The process receives a request from the user. The request is received via instant messenger and includes at least one of a set of predefined messages. The process then identifies a source of information for generating a response to the request from the user. Thereafter, the process queries the source of information using the set of predefined messages to form a response to the request from the user. The process then presents the response to the user via instant messenger.

In an illustrative embodiment, the source of information is a database accessible to the instant messenger persona of the service desk application. The database may be, for example, a table of frequently asked questions (FAQ) with commonly encountered answers. The database may also be a database of tickets. Thus, for example, if a user is seeking information relating to an open ticket or an answer to a FAQ, then the instant messenger persona may retrieve the requested information from the database and present a response to the user. In this embodiment, the instant messenger persona uses the set of predefined messages received from the user to query the database for the relevant information.

In another embodiment, if the response to the user's request cannot be found from an existing database, the source of information may be a service desk operator, a service technician, or a subject matter expert. In this embodiment, the instant messaging persona may act as an intermediary between a client and a service desk operator for exchanging information. Alternatively, the instant messaging persona may initiate an instant messaging session between the client and service desk operator to permit a real-time exchange of information. Thus, in these examples, the source of information is at least one of a database and a subject matter expert. In other words, the source of information may be a database, a subject matter expert, or both.

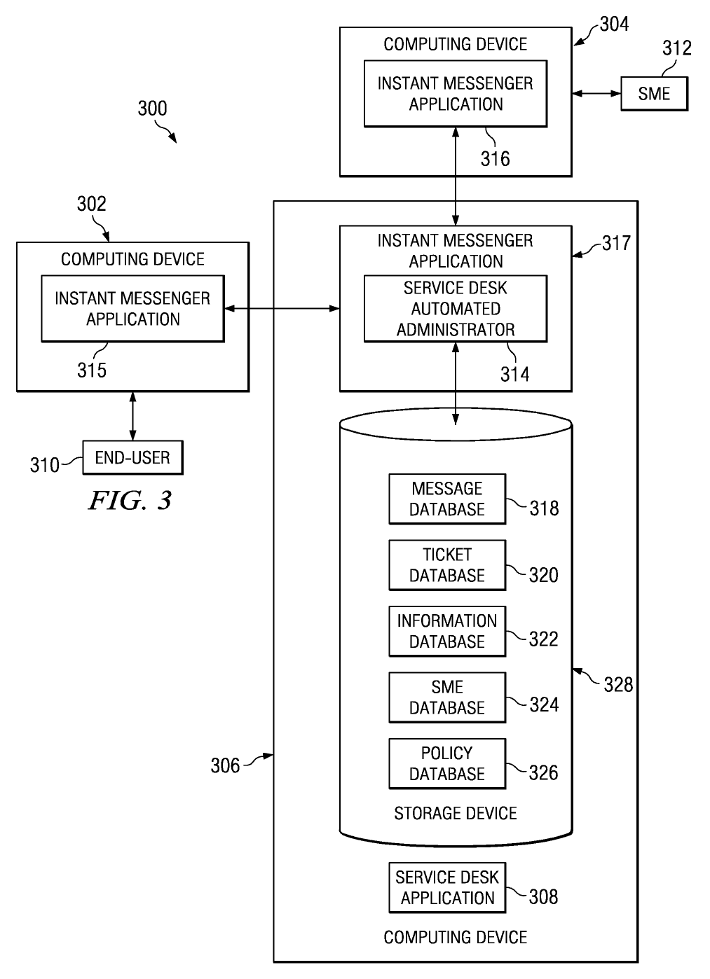

Turning now to FIG. 3, a system for managing a service desk environment is depicted in accordance with an illustrative embodiment. Service desk environment 300 is a system, such as network data processing system 100 in FIG. 1. Service desk environment 300 includes computing devices 302, 304, and 306. Computing devices 302, 304, and 306 are computing devices, such as server 106 and client 110 in FIG. 1.

Computing device 306 runs service desk application 308. Service desk application 308 is a software application operable to provide service desk functions to users of service desk environment 300. Service desk functions may include, for example, opening a new ticket, updating an existing ticket, closing a ticket, providing responses to requests for information, suggesting simple solutions to reported incidents, redirecting user inquiries to other users having the requested information, assigning tickets to available subject matter experts, generating notifications, and managing workflow generated in service desk environment 300.

In this example, service desk application 308 is the IBM® Tivoli® Service Desk. Tivoli is a registered trademark of International Business Machines Corporation. However, service desk application 308 may also be, for example, CA Unicenter®, BMC Remedy®, or any other similar type of product. CA Unicenter is a registered trademark of Computer Associates, Inc. BMC Remedy is a registered trademark of BMC Software, Inc.

Users, such as end-user 310 and subject matter expert(SME) 312 operate computing devices 302 and 304, respectively, to interact with service desk application 308 and, if necessary, with one another. In this example, end-user 310 is one or more people or organizations entitled to services from a service desk application provider. The scope of the services available to end-user 310 is often detailed in a separate agreement (not shown). Subject matter expert 312 is a subject matter expert of service desk environment 300. A subject matter expert is one or more service desk operators capable of providing end-user 310 with technical support to remedy reported problems.

In service desk environment 300, end-user 310 and subject matter expert 312 interact with one another and with service desk application 308 via service desk automated administrator 314. Service desk automated administrator 314 is a programmatic service desk operator persona that serves as a user interface to manage user requests in service desk environment 300. In this example, service desk automated administrator 314 is implemented in instant messenger applications 315, 316, and 317. Instant messenger applications 315, 316, and 317 are applications for allowing real-time conversations between two or more users over a network, such as the Internet. Instant messenger applications 315, 316, and 317 may be, for example, Lotus Sametime Instant Messenger®, AOL Instant Messenger®, MSN Messenger®, or Yahoo! Instant Messenger®, and Google Talk®. Lotus Sametime Instant Messenger is a registered trademark of Lotus Development Corporation. AOL Instant Messenger is a registered trademark of America Online, Inc. MSN Messenger is a registered trademark of Microsoft Corporation. Yahoo! Instant Messenger is a registered trademark of Yahoo! Inc. Google Talk is a registered trademark of Google, Inc.

When installed onto computing device 306, service desk application 308 configures service desk automated administrator 314 to appear as a contact in a user's instant messenger application. Thus, to end-user 310 operating instant messenger application 315 and subject matter expert 312 operating instant messenger application 316, service desk automated administrator 314 may appear as a perpetually present contact on the user's buddy list. A buddy list is a configurable collection of user-screen names in an instant messenger application, such as instant messenger applications 315, 316, and 317.

Users interact with service desk automated administrator 314 by generating and sending to service desk automated administrator 314 a set of predefined messages via an instant message. The set of predefined messages is one or more messages, each of which corresponds to a particular service desk function. Upon receiving a properly configured predefined message from a user, such as, end-user 310 or subject matter expert 312, service desk automated administrator 314 performs the corresponding service desk function. For example, end-user 310 may request service desk automated administrator 314 for a status report on an existing ticket. Thus, end-user 310 may send to service desk automated administrator 314 a properly formed predefined message, “Status, ticket 30124.” In response, service desk automated administrator 314 may query the appropriate database for the requested information on ticket 30124. Service desk automated administrator 314 presents the requested information to end-user 310 via an instant message.

Data and information necessary for providing service desk functions to users of service desk environment 300 are maintained in one or more databases. In this example, the data and information are maintained in message database 318, ticket database 320, information database 322, subject matter expert(SME) database 324, and policy database 326. These databases may be any type of database, such as a spreadsheet, relational database, hierarchical database or the like. In this example, the databases are stored in storage device 328. Storage device 328 is a device for storing computer readable media, such as storage 108 in FIG. 1 and hard disk drive 226 in FIG. 2. In addition, the databases may be stored in the operating memory of the data processing system, externally on a secondary data storage device, locally on a recordable medium such as a hard drive, floppy drive, CD ROM, DVD device, remotely on a storage area network, or in any other type of storage device.

Message database 318 is a database that stores the set of predefined messages presentable to service desk automated administrator 314 by users for requesting service desk functions. The set of predefined messages in message database 318 may be periodically updated and augmented as additional functionality is added to service desk application 308. In the event that a user forgets the proper predefined message for requesting a particular service desk function, the users may request service desk automated administrator 314 to display the entire set of predefined messages. The request also takes the form of a properly configured predefined message. For example, this predefined message may take the form of a question mark (?) or the word “help.” In another embodiment, if the user-generated predefined message does not correspond with at least one of the set of predefined messages stored in message database 318, service desk automated administrator 314 may respond by providing the user with the list of acceptable predefined messages for ease of reference.

Ticket database 320 is a database that stores tickets detailing the incidents and problems reported by end-users, such as end-user 310. Thus, when end-user 310 contacts service desk automated administrator 314 with an incident or problem, service desk automated administrator 314 generates a ticket that is stored in ticket database 320. As incidents and problems are addressed and remedied, service desk automated administrator 314 may close a ticket and delete the ticket from ticket database 320. Alternatively, once tickets are closed, service desk automated administrator 314 may remove the ticket from ticket database 320 and archive the ticket in a remote data storage device.

Information database 322 is a database for storing information relating to systems subject to a service level agreement between end-user 310 and the service desk environment provider. For example, end-user 310 may be prevented from sending or receiving email because the email server is down for scheduled maintenance. Information relating to the scheduled maintenance, such as the start time and end time, may be stored in information database 322. Consequently, service desk automated administrator 314 will be able to provide end-user 310 with the details of the maintenance if end-user 310 attempts to file a report about an inoperative email server.

Subject matter expert database 324 stores records relating to the various subject matter experts of service desk environment 300. The records may include information such as, for example, a name and employee identification number, areas of expertise, lists of pending tickets assigned to a particular subject matter expert, lists of tickets that have been previously resolved, lists of end-users who have already been assisted, vacation schedules, work schedules, or current location of the subject matter experts.

Policy database 326 is a database that stores a set of policies usable by service desk automated administrator 314 and service desk application 308 to govern the assignment of work and presentation of information within service desk environment 300. For example, newly generated and unassigned tickets may be assigned to a particular subject matter expert, such as subject matter expert 312, because subject matter expert 312 possesses the proper expertise, is available, is at a location closest to the end-user requesting assistance, has a pre-existing relationship with the end-user, or any other criteria, policy, or rule which may be set forth in subject matter expert database 324. Once assigned, service desk automated administrator 314 may continue to monitor the status of the assigned ticket. Thus, if necessary, service desk automated administrator 314 may reassign the ticket to another available subject matter expert.

Service desk automated administrator 314 generates work assignments for subject matter experts according to a set of dynamic conditions. A dynamic condition is a changing circumstance or changing condition associated with a subject matter expert. The set of dynamic conditions is one or more changing circumstances or conditions. A dynamic condition may include, for example, the number and type of assignments or tickets that the subject matter expert is expected to complete or resolve at any given time. Another dynamic condition may be the subject matter expert's current availability. Thus, if the subject matter expert is at lunch, then the subject matter would be unavailable and the assignment would be given to another available subject matter expert. The subject matter expert's current location is another dynamic condition. Thus, a ticket may be assigned to a subject matter expert who is the closest to an end-user who requires assistance.

In addition, subject matter expert database 324 may also contain one or more policies in the set of policies that limits the presentation of information to users of service desk environment 300. The limitation may be based upon the type of user. For example, both end-user 310 and subject matter expert 312 may request from service desk automated administrator 314 information contained in an existing ticket. Service desk automated administrator 314 may provide to end-user 310 less technical information than is provided to subject matter expert 312. Similarly, subject matter expert 312 may receive less personal information of end-user 310 in requesting the same information. For example, subject matter expert 312 inquiring about a ticket may be prohibited from receiving account information of end-user 310. The extent to which information is provided to either subject matter expert 312 or end-user 310 may be determined by one or more rules set forth in policy database 326.

Subject matter expert 312 may interact with service desk automated administrator 314 to facilitate the resolution of problems reported by end-user 310. For example, subject matter expert 312 may retrieve a list of tickets to which subject matter expert 312 has been assigned by sending to service desk automated administrator 314 a properly formed predefined message. If subject matter expert 312 requires additional information to begin work on a ticket, subject matter expert 312 may send to service desk automated administrator 314 a predefined message requesting additional information. For example, subject matter expert 312 may require an end-user's address so that subject matter expert 312 may perform a service call. In this event, subject matter expert 312 sends the proper predefined message to service desk automated administrator 314 for the contact information for an end-user. Once received, service desk automated administrator 314 may query ticket database 320 or information database 322 for the requested information. If the requested information is contained within the searched databases, service desk automated administrator 314 returns to subject matter expert 312 the requested information. After completing the necessary work, subject matter expert 312 may utilize service desk automated administrator 314 to update the ticket.

Service desk automated administrator 314 may also facilitate a communication session between the user and a subject matter expert. A communication session is an exchange of messages between the end-user and a subject matter expert. The messages may include, any form of information, such as text, graphics, or files. The communication session may be direct or indirect communication between end-user 310 and subject matter expert 312. Service desk automated administrator 314 may facilitate an indirect communication session by acting as an intermediary between users of service desk environment 300. Thus, if information requested by a user, such as end-user 310 or subject matter expert 312 is not found within a database, then service desk automated administrator 314 may send requests for information to another user of service desk environment 300. For example, if end-user 310 is requesting a status update for work performed by subject matter expert 312, but subject matter expert 312 has not yet updated ticket database 320 with the requested information, then service desk automated administrator 314 is not able to provide end-user 310 with the requested information. In this instance, service desk automated administrator 314 may generate a query for delivery to subject matter expert 312 using a predefined message from end-user 310. Upon receipt, subject matter expert 312 may provide service desk automated administrator 314 with the requested information. Thereafter, service desk automated administrator 314 returns the status information to end-user 310 via an instant message. If, however, a real-time conversation is necessary for facilitating the exchange of information, then service desk automated administrator 314 may initiate an instant messaging session between end-user 310 and subject matter expert 312 to enable the users to communicate directly.

In addition, if subject matter expert 312 requires additional information in order to address a reported problem, service desk automated administrator 314 may initiate a communication session with end-user 310 to obtain the necessary information. Service desk automated administrator 314 may deliver a prompt to end-user 310 seeking supplemental information needed by subject matter expert 312. If necessary, service desk automated administrator 314 may initiate an instant messaging session between subject matter expert 312 and end-user 310, if necessary, to obtain the necessary information.

Message database 318, ticket database 320, information database 322, policy database 326, and subject matter expert database 324 are stored in storage device 328. Storage device 328 is a device for storing data usable by service desk automated administrator 314 to provide services to users of service desk environment 300. The data stored in storage device 328 is the data disclosed above, stored in predefined message database 318, ticket database 320, information database 322, policy database 326, and subject matter expert database 324.

The computing devices of service desk environment 300 are shown to be executing instant messenger application 315, 316, and 317. Instant messenger applications 315, 316, and 317 may be the same instant messenger application or different instant messenger applications. For example, instant messenger applications 315, 316, and 317 may all be the Sametime® Instant Messenger application. Alternatively, instant messenger application 315 may be the AOL® Instant Messenger application, whereas instant messenger application 316 may be the Sametime® Instant Messenger application.

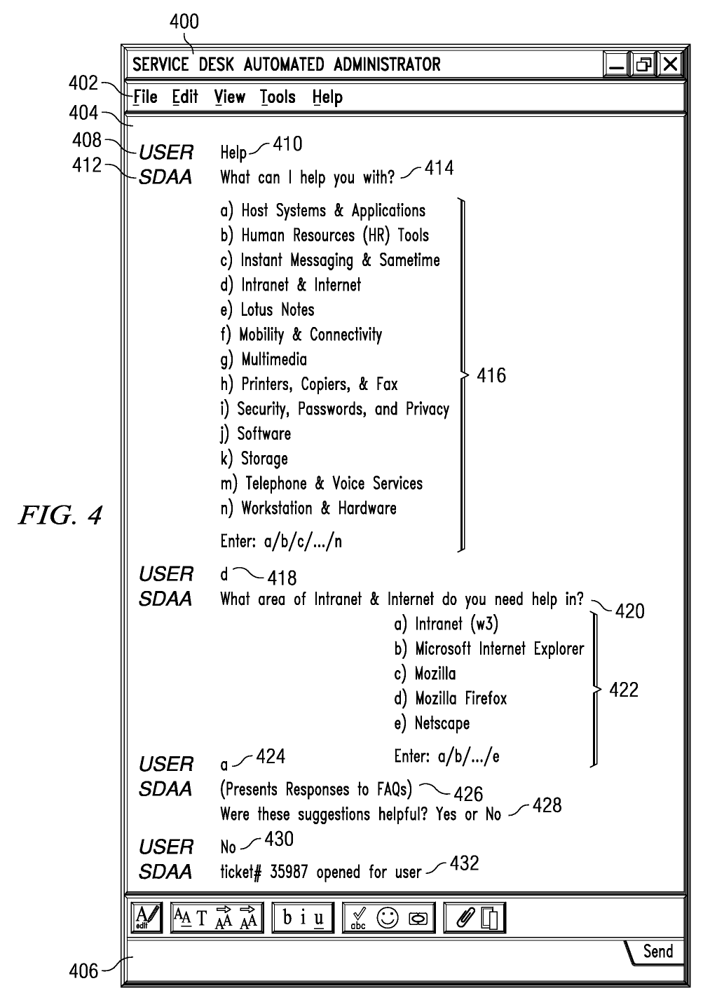

Turning now to FIG. 4, a screenshot of an instant messaging application window for use in managing a service desk environment is depicted in accordance with an illustrative embodiment. Instant messenger window 400 is a user interface for sending and receiving instant messages. Instant messenger window 400 is generated by a service desk application, such as service desk application 308 in FIG. 3. Instant messenger window 400 includes menu bar 402, chat display area 404, and text entry field 406. Users, such as end-user 310 or subject matter expert 312 in FIG. 3, may generate predefined messages or responses to prompts in text entry field 406. The predefined messages or responses are received by service desk automated administrator (SDAA) 412. Service desk automated administrator 412 is an automated instant messaging persona such as service desk automated administrator 314 in FIG. 3.

Upon receipt of the predefined message, service desk automated administrator 412 may prompt user 408 for additional information or perform a requested service desk function. For instance, in the illustrative example in FIG. 4, user 408 generates predefined message 410. In response, service desk automated administrator 412 provides response 414 and menu 416. Menu 416 is a high-level list of areas with which service desk automated administrator 412 is capable of assisting user 408.

In response to receiving menu 416, user 408 generates response 418 to select a menu item. Upon receiving response 418, service desk automated administrator 412 provides user 408 with menu 422. Menu 422 is a submenu of a menu item in menu 416. In this example, user 408 selects a menu item by providing response 424. As a result, service desk automated administrator 412 presents to user 408 response 426. In this example, response 426 includes common answers to frequently asked questions relating to the user-selected menu item.

Next, service desk automated administrator 412 provides user 408 with prompt 428. In this example, prompt 428 is an inquiry directed to user 408 for making the determination as to whether the response 426 sufficiently addressed a technical problem of user 408. Because response 426 was of no assistance to user 408, user 408 returns response 430 indicating that response 426 was not helpful. Consequently, service desk automated administrator 412 notifies user 408 in message 432 that service desk automated administrator 412 has opened ticket number 35987 for user 408. Thereafter, service desk automated administrator 412 may prompt user 408 to provide additional information about the problem encountered by user 408. Depending upon the particular implementation, service desk automated administrator 412 may query an additional database for information that may assist user 408 or service desk automated administrator 412 may forward ticket 35987 to a subject matter expert for assistance.

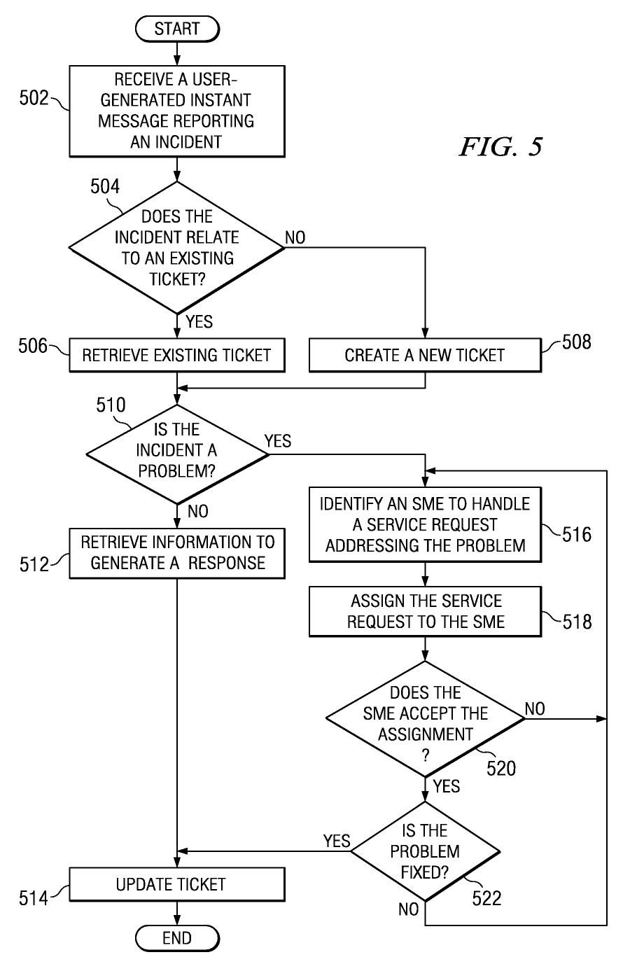

Turning now to FIG. 5, a flowchart of a process for assigning a request from a client to a service operator is depicted in accordance with an illustrative embodiment. In this illustrative embodiment in FIG. 5, the process may be performed by service desk automated administrator 314 in FIG. 3.

The process begins by receiving a user-generated instant message reporting an incident (step 502). The process then makes the determination as to whether the incident relates to an existing ticket (step 504). If the process makes the determination that the incident relates to an existing ticket, the process retrieves the existing ticket (step 506). However, if the process makes the determination that the incident does not relate to an existing ticket, the process creates a new ticket (step 508). Thereafter, the process makes the determination as to whether the incident is a problem (step 510). If the process makes the determination that the incident is not a problem, then the process retrieves information to generate a response (step 512). The process updates the ticket (step 514), and terminates thereafter.

Returning now to step 510, if the process makes the determination that the incident is a problem, the process identifies a subject matter expert (SME) to handle a service request addressing the problem (step 516). The process then assigns the service request to the subject matter expert (step 518). Subsequently, the process makes the determination as to whether the subject matter expert accepts the assignment (step 520). If the process makes the determination that the subject matter expert does not accept the assignment, then the process returns to step 516. However, if the process makes the determination that the subject matter expert does accept the assignment, then the process makes the determination as to whether the problem is fixed (step 522). If the problem is fixed, then the process returns to step 514. If, on the other hand, the process makes the determination that the problem is not fixed, then the process returns to step 516.

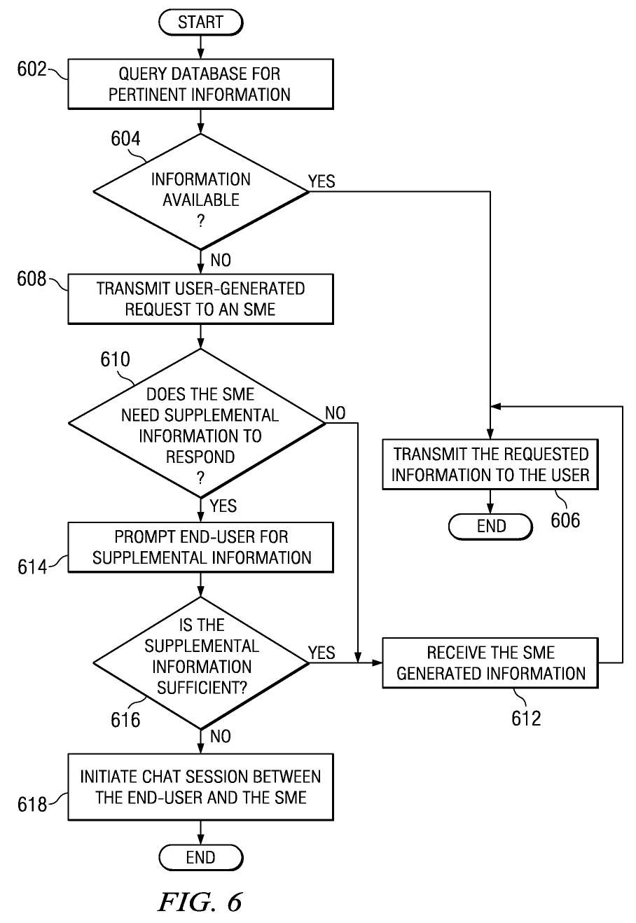

Turning now to FIG. 6, a flowchart of a process for generating a response by a service desk persona in accordance with an illustrative embodiment. In this illustrative example in FIG. 6, the process may be performed by a software component, such as service desk automated administrator 314 in FIG. 3.

The process begins by querying a database for information pertinent to the user-generated request (step 602). The process then makes the determination as to whether the information is available in the queried database (step 604). If the process makes the determination that the information is available in the database, the process transmits the requested information to the user (step 606). The process terminates thereafter.

Returning now to step 604, if the process makes the determination that information pertinent to the user-generated request is not available in the queried database, the process transmits the user-generated request to an subject matter expert (SME) (step 608). The process then makes the determination as to whether the subject matter expert requires supplemental information to respond (step 610). If the process makes the determination that the subject matter expert does not require supplemental information to provide a response, then the process receives the subject matter expert-generated information (step 612), and the process proceeds to step 606.

Returning now to step 610, if the process makes the determination that the subject matter expert needs supplemental information to provide a response, the process prompts the end-user for the supplemental information (Step 614). The process then makes the determination as to whether the supplemental information is sufficient for an subject matter expert to provide a response (step 616). If the process makes the determination that the supplemental information is sufficient for the subject matter expert to provide a response, the process proceeds to step 612. However, if the process makes the determination that the supplemental information provided by the user was insufficient, then the process initiates a chat session between the end-user and the subject matter expert (step 618). The process terminates thereafter.

The flowcharts and block diagrams in the different depicted embodiments illustrate the architecture, functionality, and operation of some possible implementations of methods, apparatus, and computer usable program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer implemented method, apparatus, and computer usable program product for managing a service desk environment. The process receives a request from the user. The request is received via instant messenger and includes at least one of a set of predefined messages. The process then identifies a source of information for generating a response to the request from the user. Thereafter, the process queries the source of information using the set of predefined messages to form a response to the request from the user. The process then presents the response to the user via instant messenger.

Using the methods and apparatus disclosed herein, response time to an end-user request is reduced. Decreased response time results in increased customer satisfaction. Further, reduced response time translates to a decrease in the amount of time an end-user's operations are affected. Further, the disclosed method eliminates the need for numerous first level service operator, resulting in decreased costs for the service desk provider. Furthermore, this solution facilitates the updating of tickets and access to information by field service technicians.

This method and apparatus may be implemented in any number of service desk environments. For example, in addition to the traditional IT service desk, the method and apparatus disclosed above may be implemented by, for example, a mail delivery company, to facilitate communication between its mail carriers, other personnel, and the end-users whose mail is being delivered.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a service desk environment, the computer implemented method comprising:
receiving a request from a user, wherein the request is received via an instant messenger and wherein the request comprises at least one of a set of predefined messages;
identifying a source of information for generating a response to the request from the user;
querying the source of information using at least one of the set of predefined messages to form a response to the request from the user; and
presenting the response to the user via instant messenger.

2. The computer implemented method of claim 1, wherein the source of information is at least one of a database and a subject matter expert.

3. The computer implemented method of claim 1, further comprising:
responsive to identifying the subject matter expert as the source of information, forwarding the request to the subject matter expert.

4. The computer implemented method of claim 3, further comprising:
responsive to detecting a need for additional information, initiating a communication session between the user and the subject matter expert.

5. The computer implemented method of claim 3, wherein the subject matter expert is identified according to a set of dynamic conditions.

6. A computer program product comprising:
a computer usable medium including computer usable program code for managing a service desk environment, the computer usable program code comprising:
computer usable program code for receiving a request from a user, wherein the request is received via instant messenger, and wherein the request comprises at least one of a set of predefined messages;
computer usable program code for identifying a source of information for generating a response to the request from the user;
computer usable program code for querying the source of information using the set of predefined messages to form the response to the request from the user; and
computer usable program code for presenting the response to the user via instant messenger.

7. The computer program product of claim 6, wherein the source of information is at least one of a database and a subject matter expert.

8. The computer program product of claim 6, further comprising:
computer usable program code for forwarding the request to the subject matter expert in response to identifying the subject matter expert as the source of information.

9. The computer program product of claim 8, further comprising:
computer usable program code for initiating a communication session between the user and the subject matter expert in response to detecting a need for additional information.

10. The computer program product of claim 8, wherein the subject matter expert is identified according to a set of dynamic conditions.

11. A system for managing a service desk environment, the system comprising:
an instant messaging application, wherein the instant messaging application facilitates transmission of information throughout the system;
a service desk application, wherein the service desk application generates a service desk automated administrator in the instant messaging application;
the service desk automated administrator, wherein the service desk automated administrator receives a request from a user, wherein the request is received via instant messenger, and wherein the request comprises at least one of a set of predefined messages; identifies a source of information for generating a response to the request from the user; queries the source of information using the set of predefined messages to form the response to the request from the user; and presents the response to the user via instant messenger.
